(19) United States
(12) Patent Application Publication
(10) Pub. No.: US 2007/0107276 A1
(43) Pub. Date: May 17, 2007

(54) Process for forming and using an embellished stone plaque and marker

(76) Inventor: Mary F. Peterson, Rose Hill, NC (US)

Correspondence Address: Mary F. Peterson, 9790 Taylors Bridge Highway, Rose Hill, NC, 28458, US

(21) Appl. No.: 11/261,819

(22) Filed: Oct. 28, 2005

(51) Int. Cl. G09F 19/00

(52) U.S. Cl. 40/124.5

(57) ABSTRACT

A process for forming a multipurpose predetermined size and shape stone plaque and marker with a display face for preserving and depicting means of the desired information and embellishments comprising the steps of: pouring cementitious material into a selected one of a group of mold forms; choosing the optional mounting step to convert the said plaque into the said marker; using a stencil system and method thereof for applying the said desired information and embellishments upon and into said display face of the wet concrete tablet in simulated sculptural relief; thus leaving the processing said wet concrete tablet to cure and harden, then subsequently thereafter, adding finishing technique means thereof.

### RELATED APPLICATION

This application is a continuation-in-part of Provisional Patent Application Ser. No. 60/618,779, filed Oct. 14, 2004 and entitled “PROCESS FOR FORMING AND USING A DECORATIVE STONE PLAQUE MARKER,” now abandoned.

### BACKGROUND OF THE INVENTION-FIELD OF INVENTION

This invention relates to a process for forming and using a stone plaque and marker with depicting means of desired information and embellishments applied in simulated sculptural relief using a stencil system and method thereof.

### BACKGROUND OF THE INVENTION

Mankind's fascination with painting and carving images dates back to the dawn of history as an artistic expression. Decorated concrete figures have moved out of the realm of eccentric folk art into mainstream yards and gardens.

Consequently, less expensive and easier methods have been developed for artistic variations of putting decorated images on selective surfaces using molds, stencils, templates, as such, for lettering, symbols, and other embellishments.

More than ever, homeowners and architects are turning to stone for its cost effectiveness, durability and stunning decorative results. Some of these now simplified techniques are seen with lawn and garden stepping stones.

With the popularity of stepping stones, there presented a need to form an embellished stone plaque and marker, according to this invention as a focal point on lawns even businesses using a simple process for forming an embellished stone plaque and marker for communicating and preserving desired information which includes images hereinafter, in the same manner that marquee signs and billboards can draw you into the printed message.

Given, smaller and some unsightly self-made wooden and metal structures, as such, do exist for depicting information mostly about addresses or advertising, but more commonly seen, are commercialized garden flags and signs constructed of wood, metal, and costly others, designed by professionals and crafters skilled in the art.

However, with these conventional structures as such, not only is the information depicted limited and scripted, but in many cases they tend to share a look-alike appearance indicating a lack of creativity.

As a further disadvantage, the less expensive lawn or garden structure can blemish the landscape tremendously for lack of paint, repair, or replacement, damaged from weather elements and poor construction.

Even with these drawbacks, conventional garden and lawn structures are popular, but according to the present inventor there is an alternative, for sometimes it's the basic technique using manual methods that can easily be overlooked to produce the most amazing results. Nothing tacky, but something different, durable, and decorative such as a personalized work of art to make a visual statement.

First and upmost, the present invention will open a line of communication unlike all others for its usefulness and personal appeal that will be accessible to anyone, even those of the most modest means and with limited skills in the art.

This desire on the part of the inventor resulted in the conception of the present invention for means of depicting any desirable information pertinent to the user on an embellished stone plaque and marker that can also transform into an eloquent lawn decor.

### PRIOR ART

The present invention provides significant advantages over current practices by simplifying the application of even sophisticated methods of stone carvings and embellishments.

Accordingly, the molding process and stenciling method for forming multipurpose plaques with simulated stone carvings is a significant combination of the present invention.

Surface coatings using stencils that simulate the appearance of brick, stones, tiles, or the like are well-known. The primary shortcomings of these stencils fail to produce a system and method to simulate stone carvings that stand out in sculptural relief.

This invention relates to a stencil system and method using cookie cutterlike stencils for forming character defining indicia upon and into a stone surface conveying desired information and embellishments that will stand out in sculptural relief.

The present invention discloses a new use for a feature seen on some cookie cutter stencils that is a significant function of this invention that apparently has been overlooked nor envisioned until now.

In reference to website, www.sugarcraft.com, entitled, “Things You Can Do With Cookie Cutters,” from seventeen pages of projects cited, the disclosed function of this invention was not mentioned.

In reference to website, www.whatcom.wsu.edu/ag/homehort/stepping₁₃ stone3.htm, entitled “Carving Concrete Stepping Stones,” step by step formation was cited for means of carving an image in relief using a transfer stencillike design, a sharp knife, or the like to redefine the shape. The stenciling method of this invention was not suggested.

Known, prior art cookie cutter stencils have a feature described as a ledge or lip seen around the exterior of the upper edge of the stencil wall. This provides a convenient edge (not seen in all cookie cutter stencils, but particularly useful to children, such as in cutting play dough or the like).

According to this invention, a prior art cookie cutterlike stencil when inverted, the ledge or lip provides a base from which the indicium—formed of the cementitious material contained within the stencil (and/or added to it)—stands out in sculptural relief. However, prior art cookie cutters even with a ledge or lip, in case of indicia not exhibiting left-right symmetry—such as letters, F, E, and B—inverting such a prior art stencil would result in the formation of a “backwards” letter on the plaque.

The prior art cookie cutter stencil wall used for cutting when inverted, according to this invention, can now serve as the “upper stencil wall” extending up to an inch from the lip, whereas the said upper stencil wall is now a griping end, but more importantly serves as a fill for cementitious material to form indicia in sculptural relief.

Another disadvantage of the prior art cookie cutter stencil is the thin stencil wall primarily designed for cutting out characters, but according to this invention, a lower stencil wall thickness of about 1/16 can cut out or simulate an indicium in recess relief.

This invention relates to an unobvious technique using cookie cutterlike stencils to get professional results commonly accredited to skillful laborers in the art. Such process and methods are disclosed herein to provide the novel and significant advantages over traditional practices.

### SUMMARY

It is a primary objective of the present invention to use a process comprising a group of mold forms to produce a predetermined size and shape stone plaque and marker used for multipurposes, and for preserving and depicting means of desired information with embellishments applied in simulated stone carving utilizing a unique stencil system and method.

In one form, a stone plaque used indoors or outdoors, according to the invention includes a predetermined size and shape molded solid body formed in cementitious material, having a display face for depicting means of desired information and embellishments applied in simulated stone carvings using a unique stencil system and method.

In another form, a marker according to the invention includes a predetermined size and shape molded solid body formed of cementitious material with embedded stakes for mounting into the ground, for readily viewing from the street, and having a display face for depicting means of desired information and embellishments applied in simulated stone carvings using an unique stencil system and method.

Either of the above forms will improve the esthetics of the surrounding area, be it used as lawn markers, or stone ornaments, such as personalized garden stones, stepping stones, memorial stones, headstones, even plaques embedded with hooks or chains and hung from existing stakes; including other plaques molded, recessed and sculpted as personalized home decor atop floors or tables to receive desired items such as candles, vanities, flower pots and numerous other utilitarian items.

It is accordingly an object of the present invention to process the desired information and embellishments on a predetermined size and shape tablet of a soft or wet substance, such as stone, clay and the like that is capable of molding into a form and hardening when it dries. The preferred substance that's more accessible to users for this invention to preserve the most durable and decorative art is ready to use concrete mix.

An objective of this invention relates to a process and method to give users full opportunities for avoidance of repetition or sameness in design, requiring little or no artistic skills, where function and beauty comes together in a graceful embellished stone.

It is another object of the present invention to process a marker tablet formed of cementitious material that has the size and weight to be considered durable and portable but capable of stable positioning horizontally or vertically into the ground.

Another object of the present invention is to provide a bottomless group of mold forms, comprising an oval, arch, and an adjustable mold form with a removable retainer wall capable of shaping four or more geometric embodiments.

It is an object of this invention to provide a couple of supporting props for the mounting step of marker thereof.

Still another object of the present invention is to provide a group of mold forms and a stencil system made from inexpensive material such as plastic, metal, or the like that is reusable, quickly and easily cleaned after use.

It is another object of this invention to provide a stencil system, comprising character stencils of a stencil set, representing letters, numbers, punctuation marks, and symbols for embellishing and wording virtually any kind of information, such as, addresses, greetings, advertising, grievances, passions, and more.

Yet another object or the invention is to provide a stencil system capable of forming simulated carved characters in stone and a simple technique to rework or reshape carving errors without the use of chisels, grinding, or expensive sandcasting machines or the like.

An objective of the present invention broadly concerns a stencil system and method used for applying simulated stone carvings upon and into a display face that is simpler in construction, more universally usable, more versatile in operation than known apparatus of this kind.

It is a further object to provide a stencil system where ease of application, sharpness of line and ease of reproduction are important factors, and equally noteworthy, having an opening or cutout formed therein and configured for the receive of the desirable fill.

Another object of this invention is to provide a stencil system that cuts, molds, shapes, recesses, and raises desired characters upon and into the surface of a wet concrete tablet while simulating the appearance of indicia formed in sculptural relief.

This invention objective further provides a plaque tablet made of cementitious material that may be easily molded, extremely long lasting, substantially impervious to the elements, easily colorable, and readily repairable.

It is an object of this invention to make a kit accessible to the public upon the production of manufactured stencils, mold forms and support props, included as well, a publication of the inventor's craft book compiled of suggested messages to use with the plaques and markers on various topics and instructions therein.

Additional objects and advantages of this invention will be set forth in part in the description of stencil sets which follow.

It is an object of the present invention to provide a stencil set and method for simulating carvings in raised relief.

It is an object of the present invention to provide a stencil set and method for simulating carvings in recess relief.

It is an object of the present invention to provide a stencil set and method for simulating carvings in sunken relief.

It is an object of the present invention to provide a stencil set and method for simulating carvings in bas-relief.

It is an object of the present invention to provide a sculpting technique for embellishing a pre-hardened plaque using a wet cementitious material, stenciling and method thereof.

It is an object of the present invention to process a wet concrete tablet for utilitarian purposes using a recess and sculpting step thereof.

### BRIEF DESCRIPTION OF THE DRAWINGS

Embodiments of the invention will now be described by way of example with references to the accompanying illustrations in which:

FIG. 1 illustrates a molded wet concrete tablet with inserted stakes positioned to receive support props.

FIGS. 2a to 2c illustrate a group of mold forms used for shaping and processing stone plaque and marker.

FIG. 3 is a perspective side view of a preferred character stencil of a stencil set for forming indicia in simulated recess relief, sunken relief, raised relief and for cutting out indicia.

FIG. 4 is a perspective front view of a hand holding a character stencil of a stencil set for forming indicia in simulated bas-relief and raised relief.

FIG. 5 is a perspective side view of a character stencil of a stencil set for forming indicia in simulated sunken relief, raised relief and for precision cut indicia.

FIG. 6 illustrates a perspective view of a preferred embodiment of an embellished lawn marker depicting desired information in simulated recess relief.

FIG. 7 illustrates a perspective view of another embodiment of an embellished lawn marker in vertical positioning depicting information in bas-relief.

FIG. 8 illustrates a perspective view of yet another embodiment of an embellished lawn marker in horizontal positioning depicting information in simulated raised relief.

FIG. 9 illustrates a perspective view of still another embodiment of an embellished lawn marker in horizontal positioning depicting desired information in simulated sunken relief.

FIG. 10 illustrates perspective views of various embodiments to demonstrate the versatility of the present invention.

FIG. 11 shows photocopies of character stencil embodiments formed in stone.

### DESCRIPTION OF THE PREFERRED EMBODIMENT

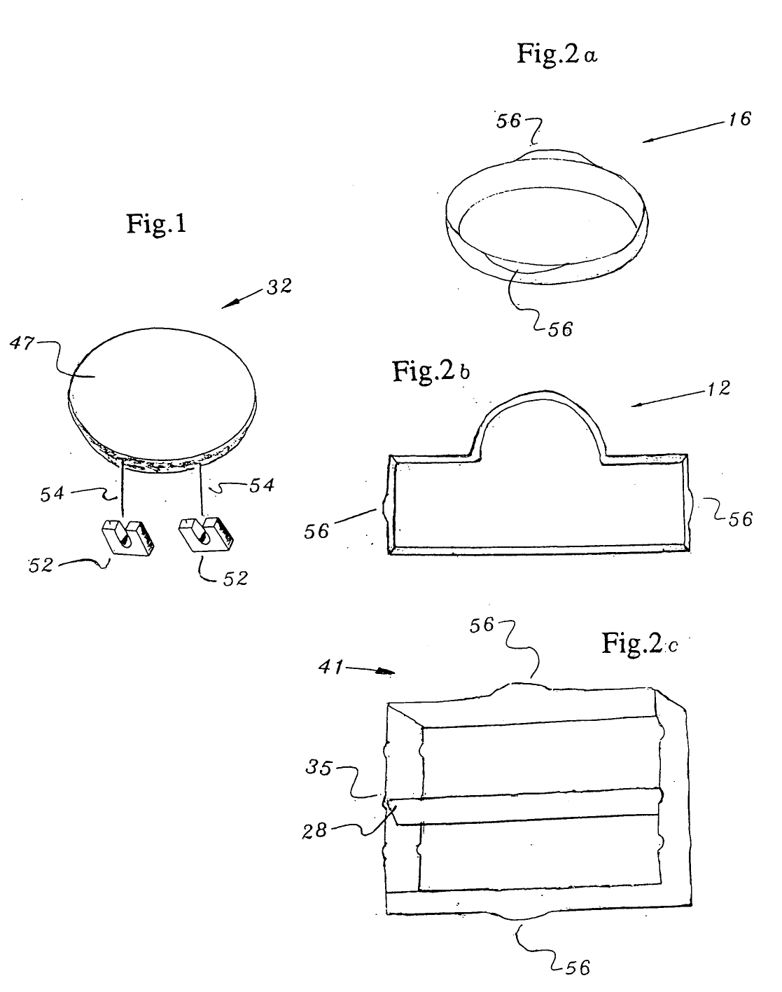

A preparatory step requires choosing a well ventilated workstation with a tabletop lined with a plastic or cloth sheet, and the use of gloves to prevent skin irritation. Turning now to the drawing, FIG. 1, there is shown a predetermined size and shape molded wet concrete tablet 32, using a pre-mixed formulation of sand and cement so called mortar or concrete, with some rocks included for a roughly texture if desired, with just enough water for a workable consistency to leave a stencil impression upon or into a wet cementitious material. If you add too much water, add more dry mix until you get the right consistency. Although a color additive or tint could be mixed in with the wet cementitious material the end product can be finished later with other coatings with just as stunning results. Using a scoop, towel, or the like (not shown) dip sufficient amount of cementitious material into an oval mold form 16 selected from group of bottomless mold forms, seen at FIGS. 2a-2c. The display face 47 of the wet concrete tablet 32 should be smoothly leveled using bottom of scoop, taking care to fill all comers of oval mold form 16, in preparation for the optional mounting step that follows, and for depicting means of the desired information and embellishments. The mounting step is necessary to process the preferred embodiment, an oval marker 24. Using handles 56, carefully remove oval mold form 16 from wet concrete tablet 32 before inserting two metal stakes 54, spikes, anchor pins, nails, or the like into base comers from edges thereof about three inches therein, depending on form selected. Leave approximately four inches of stakes 54 extending outwardly from base for mounting stability, while placing two support props 52 underneath stakes 54 extending ends for about 24 hours during cementation.

In another embodiment for vertical positioning of marker 37, turn now to FIG. 2. Shown is an adjustable mold form 41, capable of processing four or more embodiments of this invention, using grooves 35, spaced at four inch intervals along vertical inner walls of adjustable mold form 41. Furtherly, slide removable retainer wall 28 engaging grooves 35 at the selected eight inch intervals for fill of cementitious material. Remove retainer wall 28 and adjustable mold form 41 before inserting one stake 54 of about four inches therein base center of wet concrete tablet 32, leaving about four inches extending outwardly, then follow mounting steps above. Note, a retainer wall 28, can be used to slice off any cementitious portions of a wet concrete tablet 32 to shape other geometric embodiments, like squares as such. Retouch with scoop any disturbed portions of the wet concrete tablet 32 in preparation for the stenciling application.

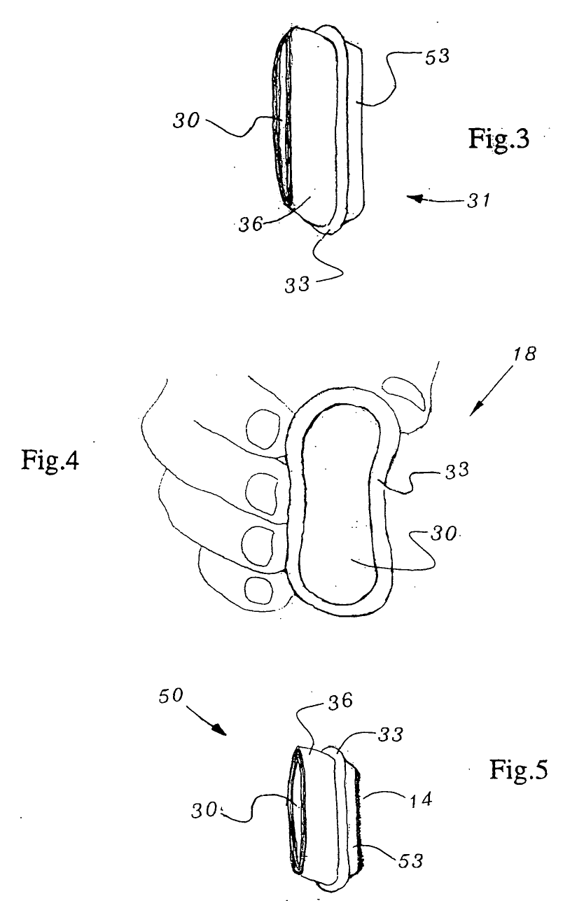

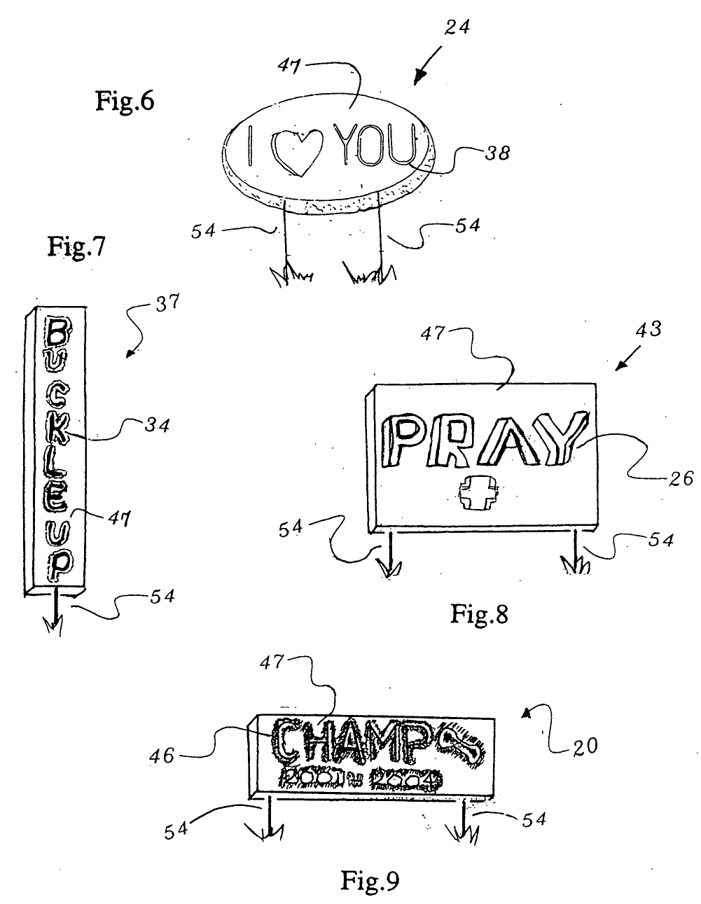

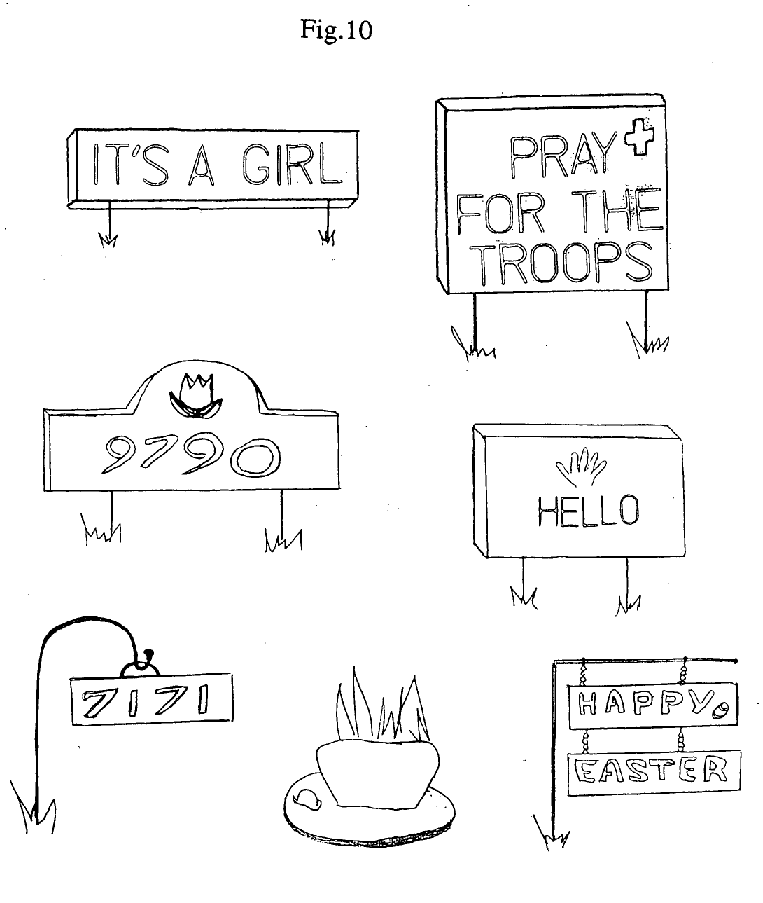

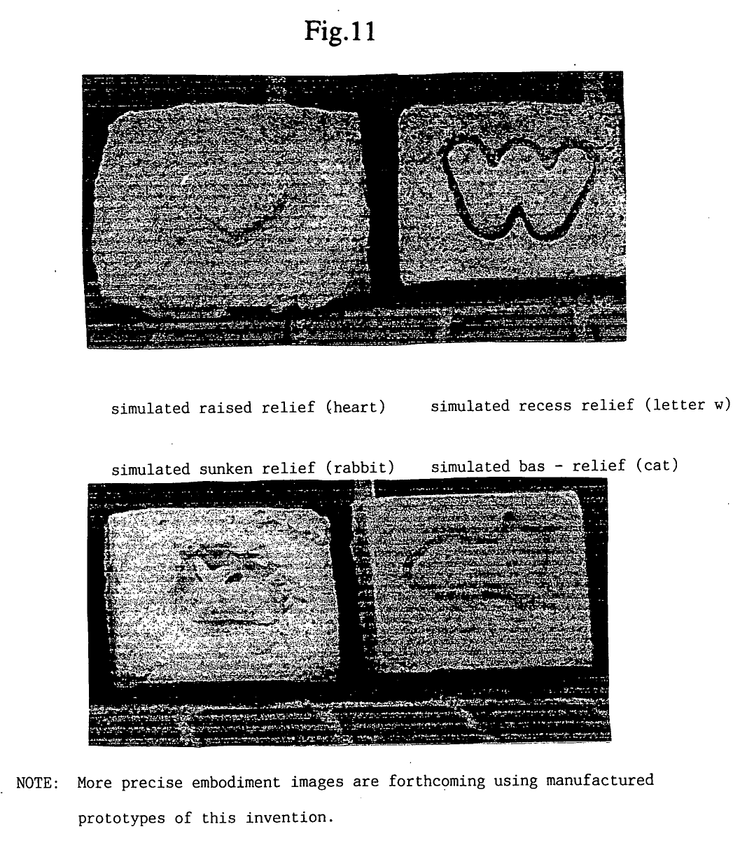

Referring now to FIGS. 3-5, shown are character stencil embodiments, representing each stencil set of the stencil system thereof. In use, an appreciation of the similarities of the stencil embodiments for depicting simulated sculptural relief carvings will be apparent from the disclosure that follows, and seen in illustrations of FIGS. 7-11; and forthcoming in Additional Embodiments and Operations.

Referring to FIGS. 3-5, there are significant similarities of all character stencils, such as, a vertical upper stencil wall 36 about 1/16 inch thick, extending one inch above lip 33, or ledge, at other times a lower stencil wall 53 extends ½ inch below lip 33.

For a detailed disclosure of two embodiments, the area surrounding an indicium such as a letter, number, punctuation mark, symbol or the like) in cementitious material, is displaced by a lip 33 around the exterior of the lower edge of character stencil 18, seen at FIG. 4. (At other times, seen at FIGS. 3 and 5, a lip 33 engages an extended ½ inch stencil wall 53). This results in a depression surrounding the indicium, which provides a base from which the indicium—formed of the cementitious material contained within the said character stencils (and/or added to it)—stands out in bas-relief. In other words, the indicium is formed in the surface by the “negative” of it around its periphery. The thus “raised” indicium may extend only to the height of display face 47 surface, or if additional cementitious material is added in opening 30 or cutout of upper stencil wall 36 of said character stencils, it may extend higher than display face 47 in “raised relief” 26, which is the second embodiment disclosed.

The preferred character stencil embodiment, turning to FIG. 3, wherein each character stencil 31 of the stencil set represents letters, numbers, punctuation marks, and symbols used to show the desired information and embellishments in simulated recess relief 38 across display face 47 of wet concrete tablet 32. Now, align character stencils 31 of the desired information and embellishments across display face 47, then impress lower vertical wall 53 about ¼ inch into surface of display face 47. Note, impressing beyond the lip 33 will form indicium in sunken relief 46. Thereafter, pull out character stencils 31 to leave the desired information and embellishments. It should be noted that the required information may use specific character stencils 31 more than once. After correctly spacing character stencils 31 impress, then lift character stencils 31 from display face 47 to reveal indicia in recess relief 38. ( Noteworthy, if stenciling error is made simply smooth out indicium with gloved finger, then redo ).

Leave the wet concrete tablet 32 undisturbed for at least 24 hours during the initial curing and hardening stage processing into a desirable end product. Next, if needed use tip of said scoop to trim off wasted concrete from around edges before applying a preferred paint coating and sealer to entire surface. Although the hardening and curing stage continues for several days the processing marker 24 can be mounted in the ground to be viewed and admired from the street, which is of course, the main function of the invention.

The finishing coating in every aspect is the required method of processing an embellished end product requiring limited skills. Although a paint coating is more desirable, other finishing techniques such as, staining, stamping, sculpting and recessing steps and the like can be used as additional embellishment means for avoidance of sameness in design.

Additional Embodiments and Operations

Another embodiment in simulated sunken relief 20, requires using character stencil 50 of the stencil set, having about one inch upper wall 36 extending downwardly about ½ inch passed lip 33, whereas the tapered edge 14 of lower wall 53 is used for precision cutting. At this point, impressing lower stencil wall 53 including lip 33 of about ¾ inch cutting deeper into surface of display face 47 will leave indicia in simulated sunken relief 46.

Another embodiment in simulated bas-relief 37, requires using character stencil 18 of the stencil set, having about one inch upper vertical wall 36 extending downwardly to lip 33, whereas impressing lip 33 of character stencil 18 into surface of display face 47 about ¼ inch leaves indicia in simulated bas-relief. Smooth out any depression lines with a gloved finger.

Another embodiment of the present invention for embellishing a pre-hardened plaque or marker not necessarily processed by this invention, using a sculpting technique requires the method of said raised relief according to an earlier step using selected character stencils of a stencil set thereof. Using said selected character stencils in predetermined locations on display face 47 of said pre-hardened plaque, fill opening 30 of upper stencil wall 36 with cementitious material. As a result of this sculpting step, embellishments will stand out in 3-D.

Another embodiment of this invention, using a molded wet concrete tablet 32 formed for said utilitarian purposes, requires a recessing and sculpting step. Let's use for an example, forming an embellished wet concrete tablet 32 as a base for the receive of symbolic images and a flower pot with a bottom smaller than the outer perimeter of said wet concrete tablet 32. In a predetermined location, recess said bottom of flower pot about one inch into surface of wet concrete tablet 32, then remove said pot leaving the recessed imprint into said base. Add symbolic images anywhere space allows applied in sculptural relief of your choice. A sculpting step might include embedding a small garden ornament such as a frog in said base before cement sets.

In addition to stencil character embodiments of this invention, the huge cookie cutter industry of symbolic images is quite useful in embellishing the most diversified stone plaque and marker in simulated raised relief, and in some instances, when left-right symmetry doesn't matter, in simulated bas-relief.

It is to be understood that the present invention is not limited to the embodiments described above, but encompasses any and all embodiments within the scope of the following claims.

What is claimed is:

1. A plaque and marker processed for multipurposes, having a viewable display face for preserving and depicting means of desired information including images and embellishments applied in simulated forms of sculptural relief using a stencil system and method thereof.

2. A plaque and marker of claim 1 wherein a one-piece molded, solid body having a predetermined size and shape said display face for viewing of said desired information and embellishments.

3. A plaque and marker of claim 1 wherein used indoors or outdoors for said multipurposes, such as lawn markers, garden stones, stepping stones, memorial stones, head stones, hanging plaques, and sculptured plaques for numerous utilitarian items.

4. A plaque and marker of claim 2 wherein formed of cementitious materials, of a soft and wet substance such as clay, or the like and is capable of molding and hardening when it dries.

5. A plaque and marker of claim 3 wherein used for said multipurposes, having the weight and size to be considered durable but capable of mobility and stability atop or into the ground in horizontally or vertically positioning.

6. A plaque and marker of claim 4 wherein said cementitious material may be easily molded, extremely long lasting, substantially imperious to the elements, easily colorable, readily repairable, and easily reworkable to correct molding errors.

7. A plaque and marker of claim 2 wherein said predetermined size and shape solid body is formed using support props, a bottomless group of mold forms comprising an oval, arch, and an adjustable mold form whereas a removable retainer wall will shape forms therein.

8. A kit of claim 1 comprising at least one craft book of suggested said desired information and instructions therein, when which will include manufactured parts to process the invention thereof.

9. The process to select one form from said group of mold forms according to claim 7 to form a said predetermined size and shape plaque and marker comprising the steps of:
mixing a sufficient amount of said cementitious material of rocks included if desired for a roughly texture, with just enough water for a workable consistency to leave a stencil impression upon or into a said wet concrete tablet; pouring said sufficient amount of said cementitious material into said selected mold form to shape said wet concrete tablet with a thickness generally equal to that of the said selected mold form, thus reserving a sufficient portion of said cementitious material for later stenciling step for the said desired information and embellishments; and leveling said cementitious material with a trowel or bottom of a scoop or the like to fill all comers to form said wet concrete tablet.

10. An optional step of claim 9 wherein mixing a predetermined amount of tint or color additive with said cementitious material for the purpose of color coating entire surface of said wet concrete tablet.

11. An optional mounting step of claim 1 wherein using a said predetermined size and shape marker having a viewable said display face for depicting means of said desired information and embellishments comprising the steps of: using handles to remove said selected mold form leaving undisturbed the freshly formed said wet concrete tablet; inserting two metal stakes, spikes or the like into base comers from edges thereof, about three inches therein said wet concrete tablet; and leaving an appropriate length of about four inches of said stakes extending outwardly from said base comers for mounting stability, further placing two support props underneath extending ends of said stakes for about 24 hours during cementation.

12. An optional mounting step of claim 11 wherein choosing marker of about 8 inches wide and about 20 inches high mounted in vertical positioning for depicting means of said desired information and embellishments using said adjustable mold form comprising the steps of: sliding removable retainer wall to engage grooves at 8 inch intervals along vertical walls of said adjustable mold form to shape the said wet concrete tablet; casting in a fill of said cementitious material; removing said retainer wall and said adjustable mold form; and inserting one of said stakes about 4 inches therein base center of said wet concrete tablet, then placing one of said support props underneath said stake end extending about 4 inches from said base.

13. A stencil system and method according to claim 1 using a stencil set of character stencils for applying said desired information and embellishments upon and into said display face of said plaque and marker in simulated forms of sculptural relief comprising:
each stencil set of character stencils represent letters, numbers, punctuations, and symbols, similar in form of cookie cutter stencils but more universally usable, and more versatile in operation with a desired height and width of less than three inches;
each stencil set of character stencils having a lip of about ⅛ inch extending outwardly from a desired one inch upper stencil wall of about 1/16 inch thickness, whereas said lip used as a depression base for forming simulated indicia carvings in the said upper stencil wall also functions as a griping end, having a cutout or opening formed therein and configured for a fill of the desired substance, in this case said cementitious material to form indicia in simulated raised relief.

14. A method of claim 13 wherein one stencil set of character stencils having a said upper stencil wall extending about one inch above said lip used for forming said desired information and embellishments in simulated bas-relief.

15. A method of claim 13 wherein one stencil set of character stencils having said upper stencil wall from said lip whereas lower stencil wall extends downwardly about ½ inch from said lip in tapered thickness for precision cuts and cutting deeper into said cementitious material to form said desired information and embellishments in simulated sunken relief.

16. The plaque and marker of claim wherein processed using said mold forms, said support props, and said character stencils made from inexpensive, lightweight material, such as plastic, metal, or the like, that is usable, quickly and easily cleaned after use.

17. A process of claim 13 for choosing the preferred stencil set of character stencils whereas the lower stencil wall of about 1/16 inch thickness extends ½ inch below said lip for cutting out indicia and for forming said desired information and embellishments in simulated recess relief comprising the steps of: aligning selected said character stencils of stencil set across said display face, (sometimes, requiring using said character stencils more than once); impressing said lower stencil wall about ¼ inch without merging said lip into said display face of said wet concrete tablet, (however, merging said lip as well forms indicia in said simulated sunken relief); and pulling out said character stencils leaving said desired information and embellishments in said simulated recess relief.

18. The process of claim 17 comprising the step of: leaving said wet concrete tablet undisturbed for at least 24 hours during initial curing and hardening stage, whereas processing continues for several days, nevertheless, finishing techniques can be applied after 24 hours.

19. The process of claim 18 wherein said curing and hardening of said plaque or marker is perimeterly trimmed of wasted said cementitious material with said scoop before preferred finishing coating is applied comprising steps of: painting after 24 hours said simulated recess relief indicia of said desired information and embellishments using a preferred squeeze bottle with nozzle; and using a contrasting color with paintbrush to paint remaining surface.

20. A process of claim 18 wherein applying a sealer as a said finishing technique for preserving said plaque marker or marker, however other said finishing techniques can be used beforehand including but not limited to sculpting and recessing steps, staining, stamping, or the like. Thus the said finishing techniques requiring limited skills will also be appreciated in avoiding repetition and sameness in design.
